(19) United States
(12) Patent Application Publication
(10) Pub. No.: US 2012/0325836 A1
(43) Pub. Date: Dec. 27, 2012

(54) Sleeve for Beverage Containers and Method of Making Same

(76) Inventor: Beth Nenniger, Calgary (CA)

(21) Appl. No.: 13/491,908

(22) Filed: Jun. 8, 2012

(30) Foreign Application Priority Data
Jun. 9, 2011 (CA) 2742445
Sep. 21, 2011 (CA) 2752933

(51) Int. Cl. B65D 81/38; B31D 3/02

(52) U.S. Cl. 220/720; 493/287

(57) ABSTRACT

A gripping sleeve for a beverage cup is disclosed. The beverage cup has an outside surface which is tapered from a smaller diameter to a larger diameter bottom to top. The gripping sleeve has an open web of material defining an expandable tube having an inner cup side surface conformable to said outside surface of said beverage cup, and an outer gripping surface, and the tube expands to a maximum tube diameter. The maximum tube diameter is smaller than the larger cup diameter but larger than the smaller cup diameter. The open web is formed from a plurality of strips of material joined together which are oriented generally radially, when viewed from above, between the inner cup side surface and the outer gripping surface. The gripping sleeve provides a gripping surface for a person holding the cup which is spaced apart from said outside surface of said cup.

### FIELD OF THE INVENTION

This invention relates generally to the field of beverage containers such as cups. In particular this invention relates to a sleeve for use in association with such beverage cups. Most particularly, this invention relates to a sleeve of the type that permits a person to comfortably hold a hot or cold beverage cup without being unduly affected by the temperature of the cup.

### BACKGROUND OF THE INVENTION

Paper or plastic cups are commonly used in quick service restaurants for hot beverages such as coffee, tea, hot chocolate and the like. Cold beverages such as frozen drinks may also be dispensed in such thin paper or plastic beverage cups. More specifically, many large retail coffee chains dispense large numbers of cups of coffee and tea in thin-walled paper cups. Such paper cups are attractive as they may be made from recycled paper and are relatively inexpensive. However, the cups upon being filled with hot coffee and tea or the like, are typically too hot to comfortably hold.

Attempts have been made in the past to overcome the problem of a too hot to hold hot beverage cup. In the past, cups have been made from a Styrofoam material which provides a greater degree of insulation. However, Styrofoam cups have fallen out of fashion, are environmentally persistent and have largely been replaced with paper cups. Another solution is to double cup the hot drink, but this is both wasteful and expensive. More recently, a number of sleeve type devices have been developed for the purpose of making hot cups easier to hold. Typically these sleeves are slightly conical in shape and fit over the bottom of the cup and slide into engagement with the side walls of the cup. In one commonly used form such a sleeve is made from relatively thick dimpled paper and is intended to reduce the temperature of the gripping portion somewhat (Canadian Patent 2,458,487). However, these sleeves are both expensive and somewhat ineffective. Generally, the sleeves are made from imprinted or thickened sheets of paper which lie parallel to the surface of the cup. When the sleeve is pressed by the griping pressure required as the person picks up the cup, the sleeve compresses and the finger tips move uncomfortably close to the hot cup surface on the inside of the sleeve. The thin sheets of paper in the sleeve are inadequate to properly reduce the temperature to make holding the cup comfortable. As a result a user will typically try to hold the cup with as little pressure as possible, leading to awkward holds and potential spills. Further, the sleeve taper must be made to match the cup taper for a secure fit, meaning that a plurality of separate sizes may be required, as each quick serve retail chain has its own size and shape of cup. Alternatively, the users will have to put up with ill-fitting sleeves if the cup taper and sleeve tapers are mismatched. Thus, while being made of paper and being recyclable, these sleeves can have certain disadvantages and can fail to adequately reduce the heat transfer between the beverage cup and a person's sensitive fingertips.

Another attempt at a sleeve has been made in the prior art and is U.S. Pat. No. 5,667,135. In this design, a flat paper sheet is provided with a plurality of slits. By grabbing the opposite ends of the sheet, the slits can be expanded creating a lattice or open web material which can be joined at the ends to form a sleeve. However, this design is also unsatisfactory. Each bridge section 18 of material is twisted and at its end is a side section 16 which is also twisted relative to the side of a cup. Therefore, if a person's finger lands adjacent to a side section or on a bridge section, the only thing between the hot cup and the finger is a thin layer which lies at an angle next to the hot cup surface. Any slight pressure will cause the material to flatten out against the cup leading to uncomfortable contact. The bridges, being made from twisted strips, means that there is a tendency for the user's fingers to press the twisted lattice flat against the cup, causing hot contact. As well, the end of each slit is a stress raiser, meaning that the material will likely tear or rip if put under stress. On balance therefore this prior device has numerous drawbacks.

Other sleeve solutions for beverage cups are shown in the following patents and patent applications:

US2004/0112949

US2006/0186129

US2010/0108694

U.S. Pat. No. 5,205,473

U.S. Pat. No. 5,222,656

U.S. Pat. No. 5,415,339

U.S. Pat. No. 5,667,135

U.S. Pat. No. 5,669,553

U.S. Pat. No. 5,794,843

U.S. Pat. No. 6,053,352

U.S. Pat. No. D550,510

What is desired is a simple and easy solution to preventing a user's fingers from coming into close contact with a beverage cup while being held by the user. Such a solution should be inexpensive and easy to manufacture while at the same time providing an environmentally friendly solution. Most preferably, such a solution would accommodate multiple sizes of cups easily and simply, within an acceptable range of sizes.

### SUMMARY OF THE INVENTION

The present invention provides an expandable tube which can be used as a sleeve on a beverage cup. The sleeve can be made from recycled paper which is readily compostable, or which can be recycled, and which is also relatively inexpensive. The present invention provides a single adaptable sleeve which can be fit to various cup tapers without difficulty. The sleeve may be made from thin strips, preferably paper strips, as noted above, which reduces the amount of material required as compared to prior art designs and yet is more effective at spacing the person's fingers away from the extreme temperature (hot or cold) of a beverage cup. The paper strips can be joined together to form an open web. The strips are preferably oriented generally radially relative to the outside circumference of the cup, when viewed from above. The joints can help to reinforce the web against gripping pressure permitting thin strips to be used. By having short spans between the joints the strips are securely held in a preferred radial orientation in the web, and are able to resist twisting or crushing under moderate gripping pressure. Further, the use of such joints reinforces the web against stress, opposite to the stress raiser of the prior art. The present invention is easy to make and can be collapsed into a compact form to facilitate shipping and storage and yet easily expanded for use by the end user.

The distance the strips project in the radial direction can vary. However, good results have been achieved when the fingers of the user are spaced at least 2 mm away from the cup surface and preferably 4-5 mm away from the surface. 7 mm also works, but may be unnecessarily large. It will be understood that the heat conduction radially outwardly along the thin strip of paper will be very poor, meaning that very little, if any, heat will be transported through the strip to the user's fingers.

Therefore there is provided according to a first aspect of the present invention a gripping sleeve for a beverage cup, said beverage cup having an outside surface having a tapered outer profile with a smaller diameter at a lower edge and a larger diameter at an upper edge, said gripping sleeve comprising:

an open web of material defining a expandable tube having an inner cup side surface conformable to said outside surface of said beverage cup, and an outer gripping surface and wherein said tube expands to a maximum tube diameter, said maximum tube diameter being smaller than said larger cup diameter but larger than said smaller cup diameter;

said open web being comprised of a plurality of strips of material joined together and being oriented generally radially when viewed from above between said inner cup side surface and said outer gripping surface; said strips being shaped to form openings in said open web between adjacent strips; said strips being dimensioned to space said outer gripping surface away from said inner cup side surface,

wherein when in place on said cup said gripping sleeve provides a gripping surface for a person holding the cup which is spaced apart from said outside surface of said cup.

According to another aspect of the present invention there is provided method of making a gripping sleeve for a beverage cup comprising the steps of:

folding a sheet of paper,

applying glue to said paper in a predetermined and alternating pattern;

pressing the glue into engagement with the folded paper to create a pattern of alternating joints and free spaces;

shearing said glued folded paper along an axis to create a sleeve blank; and

joining a top end and a bottom end of said sleeve blank together to create a gripping sleeve for a container.

### BRIEF DESCRIPTION OF THE DRAWINGS

Reference will now be made to preferred embodiments of the invention, by way of example only, with reference to the following figures in which:

FIG. 1 shows a gripping sleeve according to one embodiment of the present invention in place on a cup;

FIG. 2 shows the gripping sleeve of FIG. 1 in place on a beverage cup from above according to the present invention;

FIG. 3a shows the gripping sleeve of FIG. 1 with a partially full cup being held;

FIG. 3b shows the sleeve of FIG. 1 without the cup and in a collapsed configuration;

FIG. 4 shows a folded sheet of paper having glue applied to form a precursor of a sleeve according to one aspect of the present invention;

FIGS. 5a and 5b show the folded glued paper being formed into a stack, which is a complex precursor of the present invention;

FIG. 6 shows a close-up of the alternating glue spacing pattern according to one embodiment of the present invention;

FIG. 7 shows a cut being made into the stack of papers of FIG. 5b to form a single sleeve element;

FIG. 8 shows the top and bottom edge of the sleeve element of FIG. 6 being joined to form a gripping sleeve as shown in FIG. 1;

FIG. 9 shows a further embodiment where the width of the glue strips are varied to increase the size of the openings towards one end of the gripping sleeve of the present invention;

FIG. 10 shows a section of a gripping sleeve web pattern resulting from the glue pattern of FIG. 9;

FIG. 11 shows a different glue pattern according to a further aspect of the present invention;

FIG. 12 shows a section of a gripping sleeve web pattern resulting from the glue pattern of FIG. 11;

FIG. 13 shows a different glue pattern accordingly to a further aspect of the present invention; and

FIG. 14 shows a section of a gripping sleeve web pattern resulting from the glue pattern of FIG. 13.

### DETAILED DESCRIPTION OF THE PREFERRED EMBODIMENTS

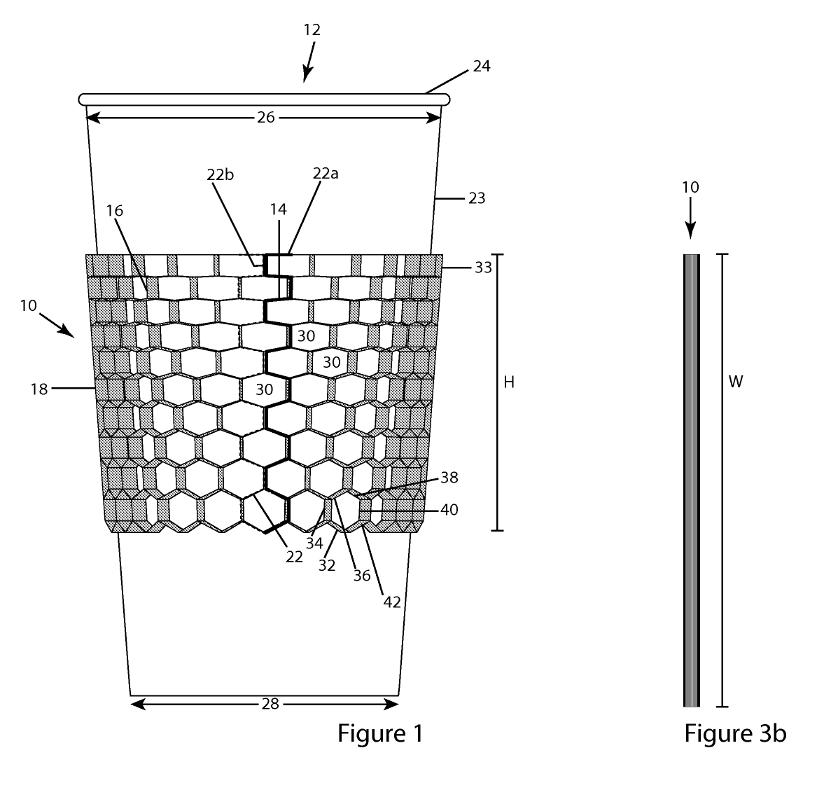

A gripping sleeve 10 for a beverage cup 12 according to a preferred embodiment of the present invention is shown in FIG. 1. As shown, the gripping sleeve 10 is comprised of an open web of material 14 which defines a tube. The web has an inner surface 16 and an outer surface 18. The inner surface conforms to the outside surface 23 of the cup 12, as explained in more detail below. The outer surface 18 defines a gripping surface.

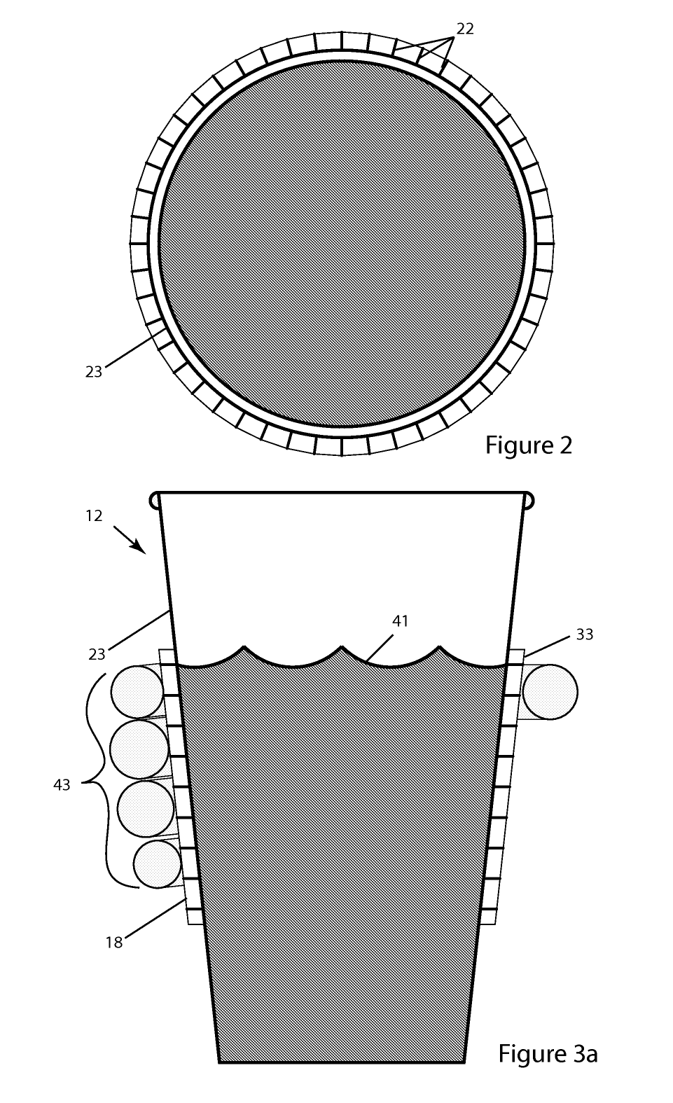

The open web of material 14 is comprised of a series of strips of material 22 which extend generally between the inner surface 16 and the outer surface 18. As shown in FIG. 2, the strips of material 22 of the gripping sleeve 10 extend generally radially outwardly from the surface of the cup 23 when viewed from above. In this sense generally radially is intended to mean extending generally outwardly, as opposed to extending generally parallel to the outer surface of the cup, as in the prior art. In side view, the strips are oriented generally parallel to the top and bottom edges of the cup 12 and thus form an angle with the surface of the cup corresponding to the taper of the cup surface 23.

The strips of material 22 may be made from any suitable material that is thin and flexible. While plastic strips are comprehended by the present invention, for environmental reasons a decomposable material such as paper is preferred. Recycled paper is the most preferred for the same reason. As will be appreciated by the explanation below, the strips can vary in thickness. The paper strips can be surprisingly thin to reduce the weight, and cost, of the present invention, but the strips have to be sufficiently thick to resist crushing under a moderate gripping pressure as might be used by a person holding a beverage cup. The Kraft paper or material weight can vary between 25 micrometers and 1000 micrometers with 60 to 80 micrometers providing adequate results. A preferred height of the strips, in this sense the length of the strip extending in the radial direction is at least 2 mm, with 4 or 5 mm being the most preferred height. Larger strips are also comprehended, but generally are not considered to be required. As will be understood height refers to the distance between the inner surface 16 of the gripping sleeve and the outer gripping surface 18.

As shown in FIG. 1, the cup has a lip or rim 24, a top outer diameter 26 and a bottom lower diameter 28. The top outer diameter 26 is larger than the bottom lower diameter 28 due to the taper of the outside of the cup 12.

In a preferred embodiment of the present invention the strips 22 are joined to adjacent strips in an alternating joint pattern. For ease of understanding strip 22 is shown joined to strip 22a with joints 22b. In this embodiment the strips run from the top edge to the bottom edge of the sleeve, but the present invention comprehends that the strips could be oriented in any direction, including 90° to the strips shown. However, having the strips oriented as shown is the most preferred.

Most preferably the open web includes apertures or openings 30. In the preferred form the openings are hexagons, having 6 equal sides. As shown in FIG. 1, a typical opening is formed with sides 32, 34, 36, 38, 40 and 42. Two opposed sides 34, 40 are each formed as a joint with an adjacent strip. In the embodiment shown, further joints extend up from the apex of 36 and 38 and if the sleeve extended downwardly from the apex of 32 and 42. Any suitable adhesive can be used, such as paper glue to form the joint as described below. It will be appreciated by those skilled in the art that the openings can be any shape. While polygons are preferred, the openings could be rounded, square, rectangular, polygonal or any other shape without departing from the spirit of the present invention.

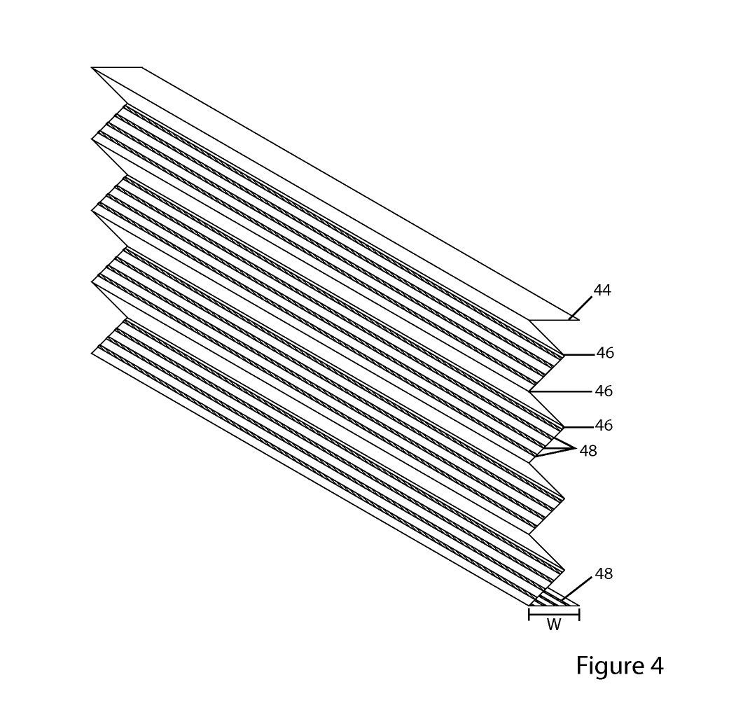

Turning to FIG. 3a, the gripping sleeve 10 is shown on the cup 12. In this figure the cup 12 is partially full of a hot liquid 41, and the fingers 43 are shown gripping the outer surface 18 of the gripping sleeve. As shown the fingers are larger than the openings, so that any finger is supported by a number of sides of one or more openings.

It will now be appreciated why a flexible strip material, such as paper, is preferred. The gripping sleeve is in the form of a tube, and due to the flexibility of the thin strips that make up the open web, the sleeve can be expanded or stretched to fit around the beverage cup 12. All that is required is to insert the bottom end of the beverage cup into the top of the sleeve and then slide the sleeve up the cup. The sleeve will conform to the shape of the cup 12 simply by expanding an appropriate amount. In this way the same gripping sleeve 10 of the present invention can be used on a variety of sizes and shapes of beverage cup, without the need for separate sleeve sizes. Of course, there are limits to how much the open web can expand in any given case, but in general one sleeve will be suitable for a range of beverage cups having slightly different diameters and slopes to the exterior cup surface.

As shown in FIGS. 1 and 3, the top layer 33 of the gripping sleeve 10 will expand to a straight line or hoop, at which point it can no longer expand without tearing. It will now be understood that the diameter of this top line is larger than the bottom diameter 28 of the cup 12 but smaller than top diameter 26 of the cup 12. In this way the sleeve 10 will expand a certain amount, and then frictionally engage the outside surface of the cup 12 at the top layer 33. The present invention further comprehends that it may be desirable to reinforce the top layer 33. Preferably the maximum diameter of the top layer 33 is larger than the average diameter of the top and bottom diameters when taken together, and more preferably is between 60% and 80% of the top diameter, so the top layer 33 of the sleeve frictionally engages the cup at a level above the midpoint of the cup which allows the gripping sleeve to be positioned on the cup 12 in a position that is comfortable for holding the cup.

While the preferred embodiment has the top layer sized and shaped to frictionally engage the cup, as will be understood by those skilled in the art, the frictional engagement can occur at any level in the sleeve, at the bottom, or middle or anywhere in between, by varying the dimensions of the sleeve 10. Thus the present invention comprehends a frictional engagement between the sleeve and the cup at one or more locations and at different locations in the sleeve and on the cup. All that is required is that the sleeve be sized and shaped to frictionally engage the cup in a manner that secures the sleeve in place on the cup when the cup is held by a person.

As an alternative the present invention further comprehends that the sleeve may be bonded to the surface of the cup. In this case a temperature sensitive glue or adhesive can be used. Such a glue is coated on the inner surfaces of the sleeve. After the sleeve is placed on the cup the glue is activated by the cup temperature and adheres to the outer surface of the cup. In this way the sleeve is secured to the cup. As will be now understood by those skilled in the art, either or both of the frictional and adhesive engagement can be used as a means for securing the sleeve to the cup, and may be referred to herein as a means for fixing the sleeve to the cup. In this sense, “fixing” means temporarily joined, bonded or frictionally secured to the cup surface. For a temperature sensitive adhesive it is preferred if it is activated in a temperature range of a normal hot beverage, such as 50° C. to 100° C. approximately.

As shown in FIG. 3b, the sleeve 10 of the present invention can also be compressed to a small size. This small size will allow more sleeves of the present invention to be stored in the same volume, which helps to reduce costs. The sleeve of the present invention can be collapsed, until it forms a tube which has a smallest possible diameter equal to the radial extension of two strips, although it will naturally try to expand to a larger diameter. Thus, it may be necessary to restrain the gripping sleeve to achieve the smaller volume. The present invention thus provides a device that requires both less volume for shipping, and less retail counter space. Both of these are important for cost control, especially in the small kiosk style retail store of many coffee shops.

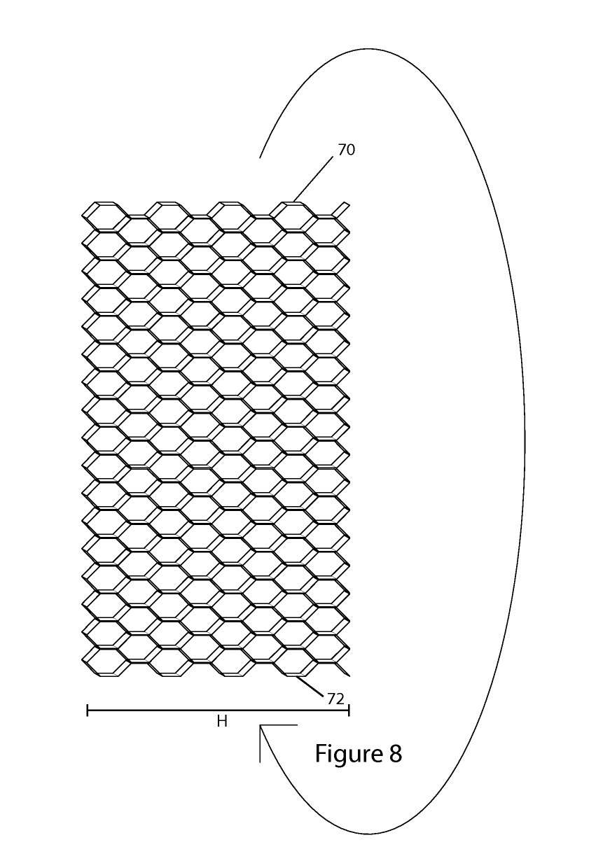

A preferred method for forming a gripping sleeve according to the present invention can now be understood. This is by way of example only and there will be other ways of forming a suitable gripping sleeve as well that are comprehended by the present invention. FIG. 4 shows a sheet of paper, such as craft paper 44, which is suitable to use in the present invention. In FIG. 4, the paper sheet 44 is folded in an accordion fashion, with each leg or fold 46 of the accordion having the same width W. As will be understood below, the distance W extends in the direction of the height of the sleeve on the cup. The longer W is, the more of the cup is covered. For a typical beverage cup, W is preferably between 5 cm and 15 cm with 9 cm being most preferred. Due to the folds, the actual height H of the sleeve along the side of the cup 23 will be less than W (see FIGS. 1 and 8). For example, a 9 cm strip when formed into the regular hexagon pattern will extend only 67.5 mm from end to end.

FIG. 4 shows strips of glue or adhesive 48 which have been applied between the folds 46 in a lengthwise manner as shown. The strips of glue are applied on one side of each fold 46 as shown. The glue strips 48 are applied on alternate faces of each fold, so, looking at the sheet of folded paper 44 it appears that the glue strips are applied only on every other fold.

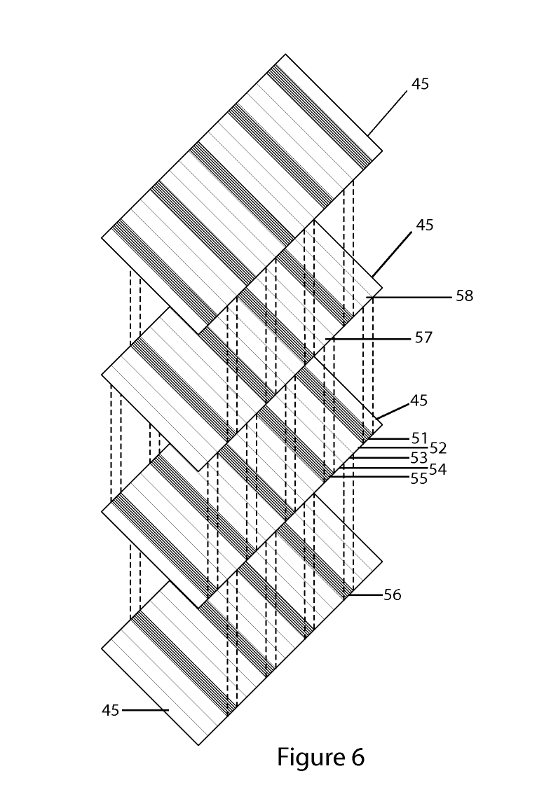

FIG. 6 shows a close up of a preferred strip gluing pattern. In FIG. 6, for ease of understanding, the folds have been shown in expanded view, so as to illustrate how the glue strips line up. There are shown four overlapping layers 45. The dashed lines 50, show where the glue strips from the face below are oriented relative to the sheet above. In this embodiment there is repeating pattern of glue strip 51, space 52, space 53, space 54 and then a glue strip 55. On the sheet below, the glue strip 56 lines up with the middle space 53. As well, the glue strips 51 and 55 line up with middle spaces 57 and 58 in the sheet above and so on. In the most preferred form an individual glue strip is the same width as the space between adjacent glue strips. This will provide a regular aperture pattern as discussed in more detail below. As well, the glue strips applied to alternate faces are applied in a precise orientation as shown, so that when folded, the glue strip on one face of a fold is opposite to a non-glue strip part of the fold on the opposite face.

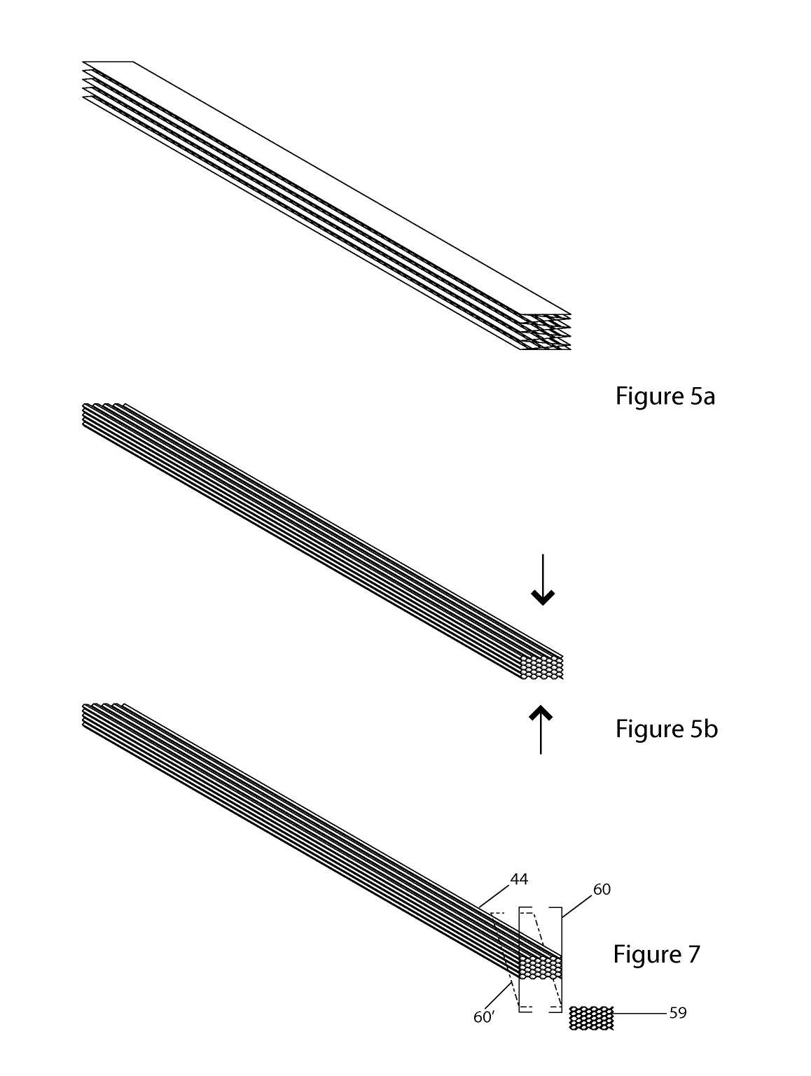

FIG. 5b shows the folded paper 44 being compressed to permit the glue strips to form joints with the adjacent clean face of the next fold. While compression and heat are not required, it is preferred to use some compression and some heat to create a secure bond or joint.

As shown in FIG. 7, the next step is to shear or cut at 60 a gripping sleeve precursor from one end of the compressed assembly of FIG. 5b. FIG. 8 shows the top face 70 can be joined to a bottom face 72 by an appropriate adhesive such as glue or the like to complete the sleeve. As can now be appreciated the coverage of the sleeve along the vertical axis of the cup 12 is determined by the width of folded over section W. The circumference of the sleeve is determined by the number of strips joined in side by side arrangement. With a hexagon opening pattern of 5 mm sides, it has been found that between 30 to 60 strips joined together will extend around most cups, with 45 to 55 strips being the preferred range. Good results have been achieved with 48 strips. In terms of the height H of the sleeve, although more or fewer could be used, reasonable results have been obtained with a sleeve having about 4 to 20 joints (alternating as shown in FIG. 1) with 8-10 being most preferred.

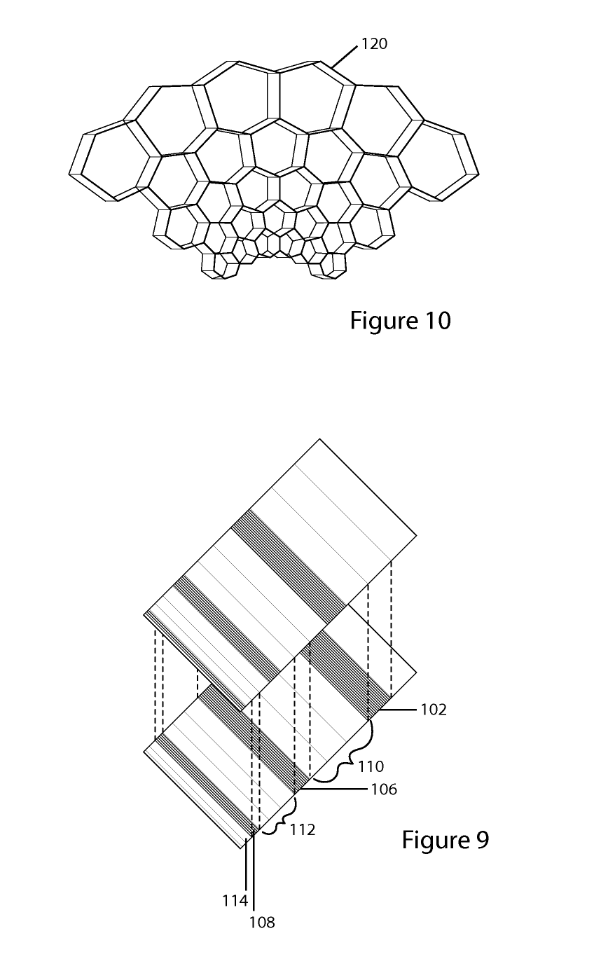

The dimensions of the openings or cells can be varied depending upon the cup size to which the sleeve is to be applied. Further, while it is preferred to use uniform cell sizes, the cell sizes can be easily varied, from sleeve to sleeve, or, even with the same sleeve. For example, if wider glue strips and wider spaces are used, the cell sizes will be larger. FIG. 9 shows a different glue strip pattern on sheet 100 to achieve such a result. The glue strips 102, 106 and 108 get progressively smaller, as well as the spaces at 110, 112 and 114. When compressed, cut and formed into a sleeve, a pattern such as partially shown as 120 in FIG. 10 results and is comprehended by the present invention. Larger cells will permit slightly greater expansion of the sleeve, than smaller cells. However, larger cells will also reduce the support, by reducing the amount of paper edge in contact with the pressure points of a user's fingers. Too large an opening would let a finger tip for example, contact the hot cup surface and thus is less desirable. Too small an aperture would require too much paper to be used and is also less desirable. A preferred size of opening is one which fits comfortably partially under a finger tip of a user. Thus, for a hexagonal aperture the preferred length of the sides of the hexagon are between 3 mm and 7 mm with 5 mm providing good results. Of course, people's finger sizes vary, so the above is simply an average that has been found to work reasonably well across the range of finger sizes of typical adults. For gripping children's drinks, such as frozen drinks such as iced slushy style drinks, a smaller aperture or opening size will be appropriate for the smaller child's finger size.

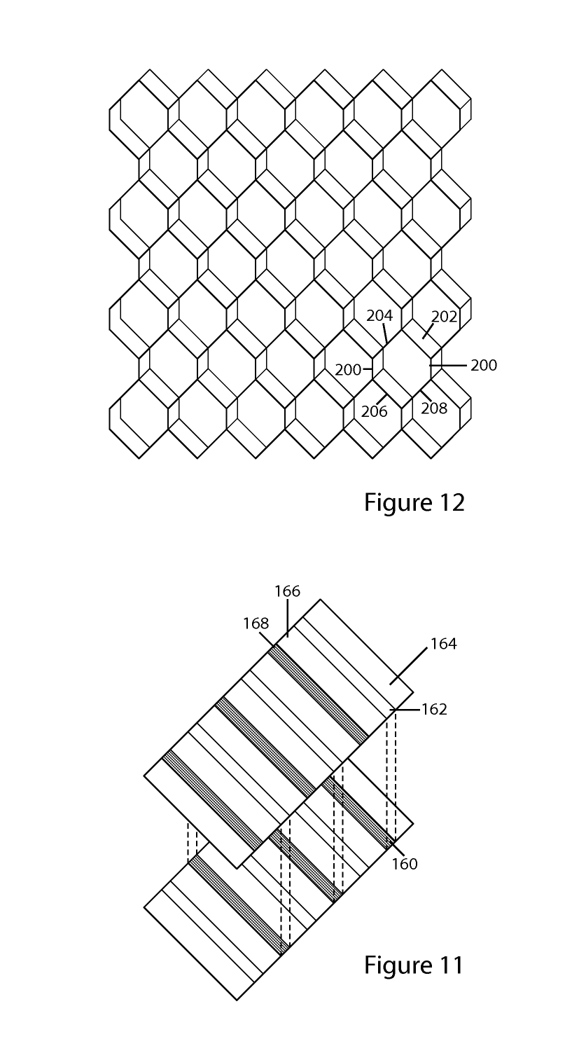

FIGS. 11 and 12 show a different glue pattern which is a further embodiment of the present invention. In FIG. 11, the glue strip 160 attaches to strip 162. Side strips 164, 166, which are wider, have no glue strip. Glue strip 168 would join to a further strip above (not shown) in the same manner as previously described for the prior embodiments. In FIG. 12 the reinforced sections 200, which is where two strips 160, 162 are joined, are smaller than the single walled sections 202, 204, 206 and 208.

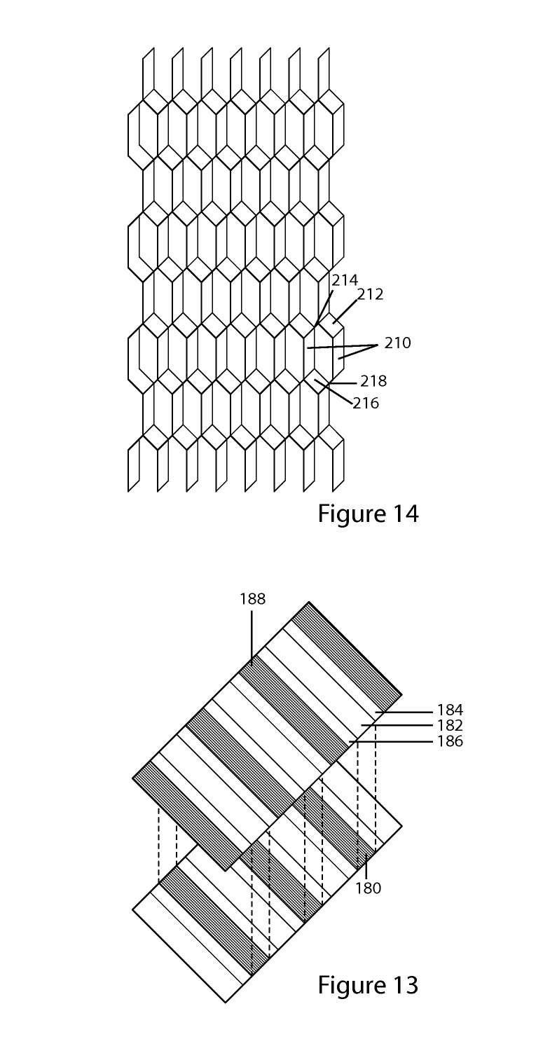

FIGS. 13 and 14 show a further glue pattern comprehended by the present invention. In FIG. 13, the glue strip 180 attaches to strip 182. Side strips 184 and 186, which are narrower, have no glue strip. Glue strip 188 would join to a further strip above (not shown) in the same manner as previously described for the prior embodiments. In FIG. 14, the reinforced sections 210, where two strips are joined by glue, are longer than the single wall sections 212, 214, 216 and 218.

It will also be appreciated that the present invention as described above provides a sleeve which has an interior surface and an exterior gripping surface which are parallel and which are parallel to the exterior surface of the cup. In some cases it may be preferred to have a different slope to the gripping surface than is provided on the cup. This is easily comprehended within the present invention by putting the cutting plane 60 at a slight angle relative to vertical shown as 60′ in FIG. 7, so that the resulting gripping sleeve is thicker at the top than at the bottom or vice versa. In other words, the strips of the open web do not extend the same distance in a radial direction at the top as compared to the bottom. In this way, a more aggressive or less aggressive taper can be provided to the gripping surface, than is provided by the cup surface itself.

It can now be appreciated how the present invention may be used. The gripping sleeve 10 may be shipped and stored in a compressed, volume reduced fashion. When needed, a sleeve can be obtained, and then expanded slightly by hand, to permit one end of a beverage cup to be inserted into one end of the sleeve. Next, the sleeve can be slid up the cup until the top layer 33 frictionally engages the cup, and the balance of the sleeve is at a comfortable gripping position on the cup. A comfortable gripping position is to have the gripping sleeve generally centered about half way up the cup, but may be further up depending upon the circumstances. This placement of the cup in the sleeve can be done either before or after the cup is filled with the beverage. According to the present invention at least a portion of the sleeve is sized to expand to a size which is smaller than the largest diameter of the cup, after which it cannot expand further. In this way the sleeve will be fixed in place on the cup at a certain amount of insertion of the cup into the sleeve as previously described. This means that the sleeve has frictionally engaged the cup and is somewhat secure on the cup by means of such a friction fit.

Thereafter, the customer can easily grip the outside gripping surface of the sleeve, without any discomfort. The strips of material are oriented to extend generally radially outwardly from the hot cup surface, meaning that the heat must transfer across the long dimension of the strip. As paper is a good insulator and as the cross-sectional area is very small very little heat will travel along the paper of the web itself. In preliminary experiments the present invention reduced the temperature at the person's finger tips by about 15° C. as compared to a prior art sleeve. The joints, at alternating faces of the open weave create some additional rigidity and strength due to the double thickness there and the glue layer, which helps to resist the sleeve inadvertently crushing under the strength of the users gripping pressure. In this way the present invention allows for a secure grip to be had with little opportunity for the fingers coming into contact with the hot cup, providing the openings are correctly sized to be generally smaller than the finger tips of the users. Of course, since the invention can be made out of paper, a stronger grip than is required for holding the hot beverage cup can cause the sleeve of the present invention to crush. What is desired is a crush resistance which is at least equal to normal gripping pressure in such circumstances, and most preferably is at least 50% to 100% more for reasonable factor of safety.

Another advantage of the present invention is its light weight which arises from a reduced amount of material required. Canadian Patent 2,458,487 discloses a sleeve which is used in the STARBUCKS™ chain. This sleeve weighs 5.3 g, whereas the same sized sleeve according to the present invention weighs only 1.1 g. The foregoing example is not intended to be limiting, but just intended to show the material savings that are possible through the open web gripping sleeve of the present invention.

As a further aspect the present invention comprehends providing a logo for display or presentation. The logo can be displayed in a number of different manners. In one embodiment the logo is printed onto the sides of the strips of the sleeve. In this way the logo is visible from the side through the web openings. In another embodiment the logo is printed on small folding sheets which fold and open to cover adjacent cells of the web of the sleeve. When the web is stretched open the folding sheets open displaying the logo which may cover several or more folding sheets and cells. Other means to display a logo can also be provided such as stickers or the like which attach by glue or adhesive to the outside of the sleeve.

It will be appreciated by those skilled in the art that many variations and modifications are possible to the present invention without departing from the broad scope of the claims which are attached. While some of these have been discussed above, other will be apparent to those skilled in the art. For example, while the present invention has been described as being made from joined strips of paper material the invention could also be made from a flexible plastic material that is molded in one step into the desired shape without departing from the scope of the invention as set out in the appended claims.

This application claims priority from CA 2742445, filed Jun. 9, 2011, and from CA 2752933, filed Sep. 21, 2011. The contents of both of these applications are incorporated herein in their entirety by reference.

I claim:

1. A gripping sleeve for a beverage cup, said beverage cup having an outside surface having a tapered outer profile with a smaller diameter at a lower edge and a larger diameter at an upper edge, said gripping sleeve comprising:
an open web of material defining a expandable tube having an inner cup side surface conformable to said outside surface of said beverage cup, and an outer gripping surface and wherein said tube expands to a maximum tube diameter, said maximum tube diameter being smaller than said larger cup diameter but larger than said smaller cup diameter;
said open web being comprised of a plurality of strips of material joined together and being oriented generally radially, when viewed from above, between said inner cup side surface and said outer gripping surface; said strips being shaped when viewed from the side to form openings in said open web between adjacent strips; said strips being dimensioned to radially space said outer gripping surface away from said inner cup side surface,
wherein when in place on said cup said gripping sleeve provides a gripping surface for a person holding the cup which is spaced apart from said outside surface of said cup.

2. A gripping sleeve for a beverage cup as claimed in claim 1 wherein said open web is formed from individual strips of material which are joined together at joints.

3. A gripping sleeve for a beverage cup as claimed in claim 2 wherein said strips of material are made from paper.

4. A gripping sleeve for a beverage cup as claimed in claim 1 wherein said openings are polygons and said web resembles a honeycomb structure.

5. A gripping sleeve for a beverage cup as claimed in claim 1 wherein said strips are flexible, and said sleeve can expand to be slid onto said beverage cup from below.

6. A gripping sleeve for a beverage cup as claimed in claim 5 wherein said sleeve can be compressed to reduce shipping and storage volume.

7. A gripping sleeve for a beverage cup as claimed in claim 1 wherein said strips have a uniform width, wherein when in place on said beverage cup said outer gripping surface is generally parallel to said outside cup surface.

8. A gripping sleeve for a beverage cup as claimed in claim 1 wherein said strips have a tapered width wherein when placed on said beverage cup said outer gripping surface is at an angle relative to said outside cup surface in side view.

9. A gripping sleeve for a beverage cup as claimed in claim 1 wherein said strips of material are sufficiently thin so as to limit heat transfer between said outside cup surface and said outer gripping surface of said gripping sleeve.

10. A gripping sleeve for a beverage cup as claimed in claim 2 wherein said joints occur at regular intervals, and said openings are of a generally uniform size.

11. A gripping sleeve for a beverage cup as claimed in claim 2 wherein said joints are spaced further apart towards one end of said sleeve and said openings are of a larger size where said joints are spaced further apart.

12. A gripping sleeve as claimed in claim 2 wherein said joints are shorter than said other sides of said openings.

13. A gripping sleeve as claimed in claim 2 wherein said joints are larger than said other sides of said openings.

14. A method of making a gripping sleeve for a beverage cup comprising the steps of:
folding a sheet of paper,
applying glue to said paper in a predetermined and alternating pattern;
pressing the glue into engagement with the folded paper to create a pattern of alternating joints and free spaces;
shearing said glued folded paper along an axis to create a sleeve blank; and
joining a top end and a bottom end of said sleeve blank together to create a gripping sleeve for a container.

15. A gripping sleeve for a beverage cup, said beverage cup having an outside surface having a tapered outer profile with a smaller diameter at a lower edge and a larger diameter at an upper edge, said gripping sleeve comprising:
an open web of material defining an expandable tube having an inner cup side surface conformable to said outside surface of said beverage cup, and an outer gripping surface;
wherein said open web of material includes a means for fixing said open web of material to said outside surface of said beverage cup.

16. The gripping sleeve of claim 15 wherein said means for fixing said open web of material to said outside surface of said beverage cup comprises an adhesive.

17. The gripping sleeve of claim 16 wherein said adhesive is a temperature sensitive adhesive which activates in a temperature range of 50° to 100° C.
